(19) United States
(12) Patent Application Publication
(10) Pub. No.: US 2004/0033298 A1
(43) Pub. Date: Feb. 19, 2004

(54) Method and apparatus for preparing oysters for consumption

(76) Inventors: Benjamin H. Nelson, Anahuac, TX (US); Tracy Woody, Anahuac, TX (US)

Correspondence Address: THE MATTHEWS FIRM, 1900 WEST LOOP SOUTH, SUITE 1800, HOUSTON, TX, 77027-3224, US

(21) Appl. No.: 10/223,864

(22) Filed: Aug. 19, 2002

(51) Int. Cl. A23L 1/00

(52) U.S. Cl. 426/506

(57) ABSTRACT

An improved method and apparatus for the preparation of raw shellfish. The method generally comprising the steps of heating the shellfish to a temperature to destroy bacterial and viral contaminants, without cooking the shellfish, and freezing the shellfish. The new and improved method and apparatus preparing the shellfish for shipment without a hold time prior to shipment.

### TECHNICAL FIELD

The present invention relates generally to an improved method for preparing raw molluscan shellfish for human consumption that reduces the amount of bacterial contamination below detectable limits. The present, improved method allowing for the immediate shipment of the shellfish to market or for preparation or consumption.

### BACKGROUND ART

Molluscan shellfish, including, but not limited to oysters, clams, and mussels) have been harvested from almost the dawn of time for human consumption. Throughout this document the term shellfish may be used exclusively, however, the shellfish is meant to include all organisms of the Class Mollusca. It may also be considered for the purposes of this document These pathogenic organisms, including, but not limited to bacteria, such as Vibrio vulnificus, the deadly Vibrio cholerae and Vibrio parahaemolyticus, has been found to proliferate in warmer waters. In fact, areas of warmer waters, such as the Gulf of Mexico, have shown dramatic increases in the amount of Vibrio vulnificus in shellfish in the warmer months. In 1999 alone, eighteen deaths were traced from the consumption of shellfish, namely oysters, collected from the Gulf of Mexico.

The majority of deaths have occurred in people who suffered from some sort of malady such as diabetes, HIV, AIDS, psoriasis of the liver, and generally any other malady resulting in the weakening of the body. However, even one death is to many and the art field has sought for methods of ensuring the elimination of the bacterial risk factor from eating shellfish.

Additionally, there is a continuing push by health and safety organizations to limit or restrict all shellfish capture along the Gulf of Mexico in the summer. This limiting of harvesting would have a dramatic effect on the market of shellfish. For example, oysters are primarily harvested from the Gulf States. Over one-half the nations supply is taken from the Gulf. Consequently, the limitations on harvesting could dramatically effect the price of oysters and the livelihood for many people who work in the oyster business along the Gulf of Mexico.

In response to this threat, various methods have been developed in the prior art to prepare a shellfish for consumption whereby substantially all of the harmful bacteria, such as Vibrio vulnificus is destroyed. These various methods were inspired, in part, from the meeting of the Interstate Shellfish State Conference (the ISSC). The ISSC was a meeting conducted by interested parties in hopes of finding a plausible regulation scheme and improved safety methods for the harvesting of shellfish. The ISSC began a push to have the total number of Vibrio vulnificus reduced to three organisms per gram of shellfish or less.

A primary shellfish that has received great attention is the oyster. This is because a lot of people eat oysters raw. A raw oyster still contains the Vibrio vulnificus. However, studies have shown that when an oyster or other shellfish is cooked at a sufficiently high temperature for a sufficient period of time the harmful bacteria, such as Vibrio vulnificus, is killed. Therefore, much of the study to date has concentrated on methods to substantially reduce the amount of harmful bacteria per gram of organism to levels that are generally regarded as safe. In fact, some methods that exist in the art have been successful in reducing the level of harmful bacteria per gram of organism to these levels. However, these methods do not reduce the risk substantially, nor do these methods ensure that there will be no further increase in the contamination levels of the shellfish after an initial processing.

One such method is disclosed in U.S. Pat. No. 5,976,601 to Tesvich et al. (the '601 patent). The method disclosed in that patent generally relates to the preparation of raw oysters. The method includes a step where the oyster is first heated to a temperature between 120.2 and 131 degrees Fahrenheit (49 and 55 degrees Celsius) for between 10 and 45 minutes depending upon the size and weight of the oyster and then cooling the oyster to a temperature below 44.6 degrees Fahrenheit (7 degrees Celsius) for fifteen minutes. The oyster is then processed for consumption. The primary object of the '601 patent is to kill harmful bacteria in the oyster to make it safer for human consumption.

The method disclosed in the '601 patent has had great effect, but still does not ensure the delivery of an oyster that is substantially free from harmful bacteria to the marketplace. The method discloses that the oyster is to remain chilled after the procedure, however, this chilling process does not ensure that future growth of the harmful bacteria will not take place prior to consumption. Accordingly, the art field is still in search of a method that ensures the delivery of an oyster that is substantially free from harmful bacteria prior to consumption.

Another prior art method that exists in the field for the treatment of oysters is U.S. Pat. No. 5,773,064 to Tesvich et al. (The '064 patent). The '064 patent discloses heat treatment and cold storage for the destruction or reduction to lower levels of harmful bacteria. This method discloses a treatment as described in the '601 patent including the steps of placing a band around the oysters before treatment. The band is disclosed to keep the hot and cold fluids from the water baths from touching the flesh of the oyster.

The process and band disclosed in the '064 patent have had some success in reducing the amount of harmful bacteria located in an oyster. However, the banding process is very time consuming and labor intensive. A separate machine must exist to place the band on the oyster or there must be sufficient personnel present to apply the bands. Additionally, the process of the '064 patent suffers from the general defects of the '601 patent in that the oyster is not ensured from generating additional harmful bacteria during transport or before consumption because the oyster is only kept at a temperature around 44.6 degrees Fahrenheit (7 degrees Celsius).

Accordingly, the art field has sought a method of preparing oysters that both is not labor intensive and ensures the delivery of an oyster that is substantially free of harmful bacteria.

Another prior art method, U.S. Pat. No. 5,679,392 to Schegan et al.(the '392 patent), discloses a method for the treatment of shellfish such as oysters to destroy the harmful bacteria. This method teaches a heat treatment and cold storage as generally disclosed in the proceeding two methods, however, the oysters are first placed in a metalized or polymer film bag to isolate the product. The method of the '392 patent requires a labor intensive step of bagging the oysters prior to treatment.

Accordingly, the art field has sought a method of preparing oysters for consumption that is not labor intensive and ensures delivery of an oyster that is free of harmful bacteria.

Another prior art method, U.S. Pat. No. 4,659,574 to Carlsson (the '574 patent), discloses a method of processing muscles. The '574 patent discloses a method wherein the muscles are first heated in a large water bath to a temperature of about 185 degrees Fahrenheit (about 85 degrees Celsius). The heating of the muscles is done under pressure to keep the muscles closed during the treatment. Then the muscles are frozen for shipment before consumption.

The method disclosed in the '574 patent does kill the harmful bacteria, but also results in the cooking of the muscle during the treatment. As such, the muscle is no longer a raw muscle, but rather a cooked muscle. This cooking results in loss of flavor and a change of texture when consumed.

Accordingly, the art field is in search of a method wherein the shellfish may be treated to destroy the harmful bacteria without the necessity of cooking the muscle prior to consumption.

Other methods in the art field, such as U.S. Pat. No. 4,537,149 to Ryan and U.S. Pat. No. 5,186,121 to Smith, Jr., disclose methods of depurating shellfish by the irradiation of water that is continuously flowed over the shellfish and filtered to remove the harmful bacteria and impurities. These methods maybe successful in removing substantially all of the harmful bacteria and impurities, but result in an irradiated shellfish and a time and labor intensive process.

Accordingly, the art field has sought a method whereby a shellfish may be treated to remove substantially all of the impurities without a time and labor intensive process.

Therefore, a method is sought in the art field whereby a shellfish may be treated to destroy substantially all of the harmful bacteria, to make the shellfish safe for consumption, without a time or labor intensive process while maintaining the flavor of a raw shellfish.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 is a diagrammatic representation of a flowchart of an embodiment of the present invention.

FIG. 2a is an illustration of an embodiment of an apparatus for preparing raw shellfish for consumption.

FIG. 2b is an illustration of an alternate embodiment of an apparatus for preparing raw shellfish for consumption.

### GENERAL DESCRIPTION AND PREFERRED MODE FOR CARRYING OUT THE INVENTION

Various embodiments of the invention will be described in the following paragraphs. Different reference numerals have been used in each illustration in an effort to more clearly define the invention. However, the different reference numerals when applied to common parts in the different illustrations do not indicate that the parts are not the same and not describing a common invention. The different reference numerals represent the scope of the invention and are not meant to limit the embodiments of the invention.

This disclosure will often refer to shellfish. Shellfish are defined to include all organisms of the Class Mollusca. In an embodiment the shellfish is an oyster.

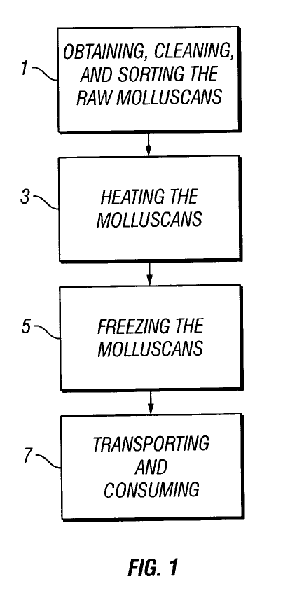

Referring now to FIG. 1, a diagrammatic representation of a flowchart of an embodiment of the present invention, a general flowchart is illustrated showing some general steps of an embodiment of the present invention. The first step in an embodiment of the present invention is to obtain, clean and sort the shellfish 1. Obtaining the shellfish may be by any means common in the art. The obtaining is typically accomplished by harvesting or capturing the shellfish from the sea or water. However, the present invention envisions other methods of obtaining the shellfish. Once the shellfish are obtained it must be cleaned. The cleaning of the shellfish is common in the art and typically entails washing off mud and debris as well as separating and breaking off extra growth. It is common in the art to have this step performed by hand, but a cleaning apparatus is also within the scope of this invention. Finally, the obtained and cleaned shellfish are sorted. Sorting shellfish is common in the art. Typically, shellfish may be sorted according to size, weight and grade. However, there exist other classifications within which to sort and such classifications are within the scope of this invention.

The second step of this embodiment is to heat the shellfish 3. The shellfish are heated to a temperature sufficient to destroy any pathogens such as bacteria and other organisms. The shellfish are generally heated to a temperature of about 100 to 145 degrees Fahrenheit (37.78 to 62.78 degrees Centigrade). The variance in temperature is dependant on the size, shape and number of shellfish being heated. The shellfish are typically heated for an interval of about 5 to 15 minutes depending on the size, shape and number of shellfish. This heating process may kill the shellfish, but preserves it in a raw uncooked state for future use or consumption. An embodiment utilizes a temperature about 100-122 degrees Fahrenheit (37.78-50 degrees Centigrade). The utilization of temperatures sufficiently within this range have been shown to destroy the harmful bacteria while not killing the oyster. However, the interval of heating must be sufficient to destroy substantially all of the pathogens. Accordingly, varying temperatures maybe used and still remain within the scope of the claims of the present invention.

The shellfish may be heated in any environment sufficient to achieve the necessary temperature. In an embodiment, the shellfish is placed in a water bath. The water bath is heated to a temperature of about 100 to 145 degrees Fahrenheit (37.78 to 62.78 degrees Centigrade). The shellfish is heated in the water bath for about 4 to 15 minutes. The heating of the shellfish at about this temperature, for about this time, will substantially destroy the pathogens to a level below detectable limits without cooking the shellfish. Thereby leaving the shellfish in a raw state after heating.

The interval of heating the oyster is dependant upon several factors. Most importantly is the temperature of the heating. At the temperature range of 100-122 degrees Fahrenheit (37.78-50 degrees Centigrade) times should vary from about 10-15 minutes.

Alternate heating embodiments of the present invention utilize a steam system. The shellfish are placed in the steam system and steamed at a temperature of about 212 degrees Fahrenheit (100 degrees Centigrade) for a sufficient time to kill the pathogens. The sufficient time is about 2 to 10 minutes. An embodiment utilizes a time of aboput 6 minutes.

In an alternate embodiment, the shellfish are placed on a conveyor system, the conveyor system conveying the shellfish through a steam system. The steam substantially surrounds the shellfish penetrating the shellfish to destroy the pathogens.

After heating, the step of freezing the shellfish 5 is performed. The shellfish may be frozen by any method or manner common in the art such as a freezer or gas injection system. In an embodiment, the shellfish are loaded on a freezing system such as a quick freezing system. In another embodiment, the shellfish are loaded onto a conveyor system and passed through a quick freeze tunnel. The quick freeze tunnel freezes the shellfish. In an embodiment, the shellfish is conveyed through a gas injection tunnel. The gas injection tunnel injecting gas at a sufficiently low temperature to freeze the shellfish. In an alternate embodiment, the quick freeze gas injection tunnel utilizes a Carbon Dioxide gas that is injected such that it substantially surrounds the shellfish, thereby freezing the shellfish.

The shellfish are conveyed through the gas injection tunnel for a sufficient time to freeze the shellfish. The time required to freeze the shellfish is about 3 to 4 minutes. However, this time may vary according to the temperature of the freeze system and the length and speed of a conveyor system.

During the freezing step, the shellfish is glazed. The glazing is encasing the shellfish with a liquid that freezes in the freezing environment. An embodiment uses water as a liquid.

The shellfish complete the freezing step encased in the frozen liquid. This encasement of the shellfish prevents further contamination of the shellfish and further decomposition of the shellfish. Additionally, the glazing of the shellfish dispenses with the need to artificially clasp, clamp or secure a shellfish, such as an oyster, to keep it from opening after treatment thereby saving time, manpower and resources from being required to place a device or substance around the oyster to keep it closed.

The shellfish may be immediately shipped or consumed after treatment without any refrigeration holding period. If the shellfish is to be stored prior to shipment, the shellfish are stored in cold storage at a temperature of about 0 degrees Fahrenheit (−17.78 degrees Centigrade) to keep the shellfish frozen and encased in the frozen liquid. However, the temperature may vary according to usage. In an embodiment, the cold storage or refrigeration storage is at a temperature equal to or less than 0 degrees Fahrenheit (−17.78 degrees Cesius).

Experimental results from embodiments of this method have been shown to reduce the number of pathogens to undetectable levels. Experimental results are illustrated in Example 1.

The scope of the present invention encompasses various embodiments designed to perform the method. Two embodiments of an apparatus of the present invention are disclosed herein following.

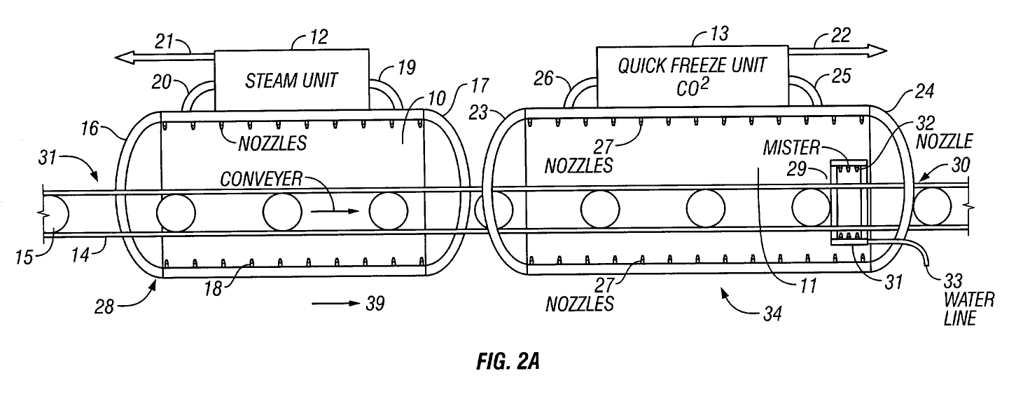

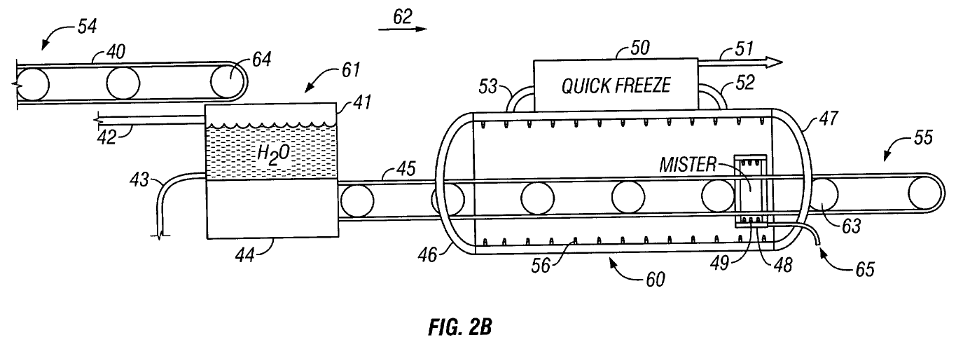

Referring now to FIG. 2a an embodiment of an apparatus is illustrated to perform the disclosed method. FIG. 2a illustrates a steam system 28 and a quick freeze system 34 with a conveyor 14 belt passing through both.

The shellfish (not shown) would be loaded onto the conveyor 14 about the end adjacent steam system 28 at about location 31. The direction of conveyor 14 is illustrated by arrow 39 below steam system 28 and is turned by gears 15 that are connected to a motive supply such as an engine or electrical connection. As the shellfish are loaded onto conveyor 14, it is conveyed into steam system 28.

Steam system 28 is composed of body surrounding the conveyor 14 to provide containment of the steam within the steam system 28. A steam generation unit 12 is located about the steam system to provide a constant or pulsating supply of steam to interior 10. A liquid, such as water, and a power supply, such as electricity, may be conveyed to steam generation unit along lines 21. The steam generation unit will heat the liquid to a temperature of above 212 degrees Fahrenheit (100 degrees Centigrade) and inject the water into the interior of steam system 28 about the shellfish through ports 18. The steam system 28 has a plurality of ports 18 located along the body of steam system 28 to provide a 360 degree area of steam injection to the shellfish (not shown). The steam may exit the steam generator 12 at connector 19 and be transferred to steam lines 16 and steam lines 17. The steam system also may re-circulate the steam through a connector 20 for reheating.

The shellfish (not shown) travel along conveyor 14 for about 4 to 8 minutes within the body of steam system 28. Accordingly, the length of the conveyor 14 or speed at which the gears 15 turn are adjusted to allow for a varying time in the steam system 28.

After the shellfish (not shown) passes along the conveyor from steam system 28 it passes into the quick freeze system 34. Quick Freeze system 34 generally comprises a body that surrounds conveyor 14. A quick freeze generator 13 is located about the quick freeze system 34 to provide an injection of a substance that freezes the shellfish as it passes through. An embodiment utilizes a Carbon Dioxide gas as the quick freeze substance. The Carbon Dioxide and electricity may be supplied through lines 22. The Carbon Dioxide is injected as a gas at about −60 degrees Fahrenheit (−51.11 degrees Centigrade) through ports 27. Ports 27 are located on lines 23 and lines 24 along the interior surface of quick freeze system 34. Quick freeze system 34 has a plurality of ports 27 and is constantly re-circulated through connectors 25 and 26. However, various other embodiments may use any temperature of injection that freezes the shellfish.

Towards the end of quick freeze system 34 is a glazing system 31. Glazing system 31 provides a mist of a liquid, preferably water, through ports 32 supplied from line 33. The glazing system 31 provides an adequate amount of water to substantially encase the shellfish (not shown).

The shellfish will pass through the quick freeze tunnel in about 1 to about 6 minutes. Accordingly, the length of the quick freeze system 34 and conveyor 14 should be of an appropriate length.

After passing through the quick freeze system 34, the frozen, encased shellfish are ready to be packaged and delivered. The shellfish may be transported from location 30 to a delivery truck, van or bus or to a freezer for storage until shipment.

In an embodiment, the length of conveyor 14 and speed at which gears 15 turn is adjusted such that a continues number of shellfish may be processed without requiring any stops or adjustments to the system.

Now referring to FIG. 2b, an alternate embodiment of an apparatus that employs embodiments of the present method is illustrated. FIG. 2b illustrates a water bath system 61 and a quick freeze system 60 with a conveyor 45 belt transporting shellfish (not shown) to water bath system 61 and conveyor 45 belt passing through quick freeze system 60.

The shellfish (not shown) would be loaded onto the conveyor 40 about the end adjacent water bath system 61 at about location 54. The direction conveyor 40 and 45 transport shellfish is illustrated by arrow 62 above the system. Conveyors 40 and 45 may be turned by gears 63 and 64, or any other means common in the art, that are connected to a motive supply such as an engine or electrical connection. As shellfish are loaded onto conveyor 40, it is conveyed into water bath system 61.

Water bath system 61 is composed of body, such as a tank or container that holds hot or heated water for heat treating the shellfish. A hot or heated water generation unit 44 is located about the water bath system to provide an amount of hot or heated water to cover the shellfish as they are conveyed into water bath system 61. A liquid, such as water, and a power supply, such as electricity, may be conveyed to the steam generation unit along lines 42. The water bath system will heat the water to a temperature of above 100 degrees Fahrenheit (37.78 degrees Centigrade). The shellfish will remain in water bath system 61 for greater than 2 minutes. In another embodiment, the shellfish will remain in the water bath system for about 2 to about 8 minutes. In another embodiment, the shellfish will remain in the water bath system for about 3 to about 6 minutes. In other embodiments, the shellfish remain in the hot water for a period of time necessary to destroy harmful bacteria.

The shellfish will then be passed out of water bath system 61 and onto conveyor 45 by means common in the art, such as poring, dumping or conveying. Water from water bath system 61 may then be discarded, either before or after the shellfish are conveyed from the system. In an embodiment, the water is sterilized on or off site and then pumped into the sewer. In another embodiment, the water is sterilized on site and then recycled for another shellfish.

The shellfish (not shown) travel along conveyor 45 and pass into quick freeze system 60. Quick Freeze system 60 generally comprises a body that surrounds conveyor 45. A quick freeze generator 50 is located about the quick freeze system 60 to provide an injection of a substance that freezes the shellfish as it passes through. An embodiment utilizes a Carbon Dioxide gas as the quick freeze substance. The Carbon Dioxide and electricity may be supplied through lines 51. The Carbon Dioxide is injected as a gas at about −60 degrees Fahrenheit (−51.11 degrees Centigrade) through ports 56. Ports 56 are located on line(s) 46 and line(s) 47 along the interior surface of quick freeze system 60. Quick freeze system 60 has a plurality of ports 56 and is constantly re-circulated through connectors 52 and 53. However, various other embodiments may use any temperature of injection that freezes the shellfish.

Towards the end of quick freeze system 60 is a glazing system 48. Glazing system 48 provides a mist of a liquid, preferably water, through ports 49 supplied from line 65. The glazing system 48 provides an adequate amount of water to substantially encase the shellfish (not shown).

The shellfish will pass through the quick freeze tunnel in about 1 to about 6 minutes. Accordingly, the length of the quick freeze system 60 and conveyor 45 should be of an appropriate length. Modifications in the length of quick freeze system 60 and conveyor 45 may be made to enable the shellfish to remain in the system for a requisite period of time. As well, the speed of gear(s) 63 may be adjusted to enable the shellfish to remain in the system for a requisite period of time.

After passing through the quick freeze system 60, the frozen, encased shellfish are ready to be packaged and delivered. The shellfish maybe transported from a location 55 to a delivery truck, van or bus or to a freezer for storage until shipment.

In an embodiment, the length of conveyors 40 and 45 and speed at which gears 63 and 64 turn is adjusted such that a continues number of shellfish maybe processed without requiring any stops or adjustments to the system.

### EXAMPLE 1

An embodiment of the present invention was tested at Texas A&M University, using protocol recommended by the USFDA, for a comparison of the treatment results of an embodiment of the present invention as compared to prior art treatments and untreated shellfish as herein below set forth. Each sample consisted of 12 oyster shellfish with meat and liquor included. In the following table, US stands for untreated samples, IQF stands for the prior art quick freeze process, and HS/IQF stands for an embodiment of the present invention. The results are Vibrio Vulnificus per gram of oyster.

| | SX 1 | SX 2 | SX 3 | SX 4 | SX 5 |
|---|---|---|---|---|---|
| US | 7.4 | 6.2 | 114 | 114 | 11.2 |
| IQF | 3.6 | 7.4 | 3.6 | 3 | 0 |
| HS/IQF | 0 | 0 | 0 | 0 | 0 |

As can be seen, results of the present invention reduced levels of the Vibrio Vulnificus to below detectable limits.

While a single method and embodiment has been shown and described, it will be understood that the invention is not limited thereto, since many modifications may be made and will become apparent to those of ordinary skill in the art.

What is claimed is:

1. A new and improved method for reducing the amount of a potentially harmful bacteria and viruses in at least one oyster, the method comprising the steps of heating the at least one oyster to a temperature above 100 degrees Fahrenheit (37.78 degrees Centigrade), the at least one oyster heated for a sufficient time to destroy the potentially harmful bacteria and viruses, thereafter freezing the at least one oyster, the freezing reducing decomposition of the at least one oyster prior to consumption and preventing growth of the potentially harmful bacteria and viruses.

2. The method of claim 1 wherein the heating the at least one oyster is performed in a water bath.

3. The method of claim 1 wherein the at least one oyster is heated for about ten minutes.

4. The method of claim 1 wherein the freezing of the at least one oyster comprises freezing the at least one oyster in an environment of about −10 to −90 degrees Fahrenheit (−23.33 to −67.78 degrees Centigrade) for about 2.5 to 4.5 minutes.

5. The method of claim 4 wherein the environment is a gaseous environment.

6. The method of claim 5 wherein the gas is at least partially Carbon Dioxide.

7 The method of claim 4 further comprising the step of glazing the at least one oyster, the glazing accomplished by an injection of water during the freezing that substantially encases the at least one oyster in ice, the encasing of the at least one oyster in ice reducing a tendency of the at least one oyster to open after preparation thereby removing a necessity of an artificial closure of the at least one oyster prior to preparation.

8. The method of claim 1 wherein the heating the at least one oyster is performed by a steam system, the steam system utilizing steam at a temperature above 212 degrees Fahrenheit (100 degrees Centigrade).

9. The method of claim 8 wherein the at least one oyster is heated in the steam system for about 2 to 8 minutes.

10. A new and improved method of preparing raw shellfish, the method destroying harmful bacteria and viruses and allowing for prompt shipment of the shellfish without the necessity of a refrigerated storage period prior to shipment, the method comprising the steps of placing the shellfish in a hot water bath for destroying the bacteria and viruses thereafter freezing the shellfish whereby the shellfish remain frozen until consumption.

11. The method of claim 10 wherein the water bath is heated to a temperature of above 100 degrees Fahrenheit (37.78 degrees Centigrade) for a time interval of about 4 to 12 minutes, the time interval varying depending upon the shellfish.

12. The method of claim 10 wherein the step of freezing the oysters is performed by a gas injection system at a temperature of about −10 to −90 degrees Fahrenheit (−23.33 to −67.78 degrees Centigrade) for about 2.5 to 4.5 minutes.

13. The method of claim 10 wherein the step of freezing the shellfish further comprises glazing the shellfish, the glazing substantially encasing the shellfish in ice.

14. The method of claim 13 wherein the step of glazing the shellfish comprises misting the shellfish with a liquid, the liquid freezing whereby the shellfish is substantially encased in ice.

15. The method of claim 14 wherein the liquid is water.

16. The method of claim 10 wherein the step of heating the shellfish comprises steaming the shellfish for a sufficient time to destroy the bacteria.

17. The method of claim 10 wherein the shellfish is a whole oyster.

18. The method of claim 17 wherein the oyster is on a half shell.
